(19) United States
(12) Patent Application Publication
(10) Pub. No.: US 2026/0022039 A1
(43) Pub. Date: Jan. 22, 2026

(54) CAPACITIVE DEIONIZATION ELECTRODE AND METHOD FOR MANUFACTURING THE SAME

(71) Applicants: SIONTECH CO., LTD., Daejeon (KR); KYUNGDONG NAVIEN CO., LTD., Pyeongtaek-si (KR)

(72) Inventors: Kyung Seok KANG, Daejeon (KR); Hyun Woo YOO, Daejeon (KR); Soo Man HWANG, Daejeon (KR); Kyung han LEE, Daejeon (KR); Seungkil SON, Seoul (KR); Sooyoung LEE, Seoul (KR); Youngjo LIM, Seoul (KR); Hooyoung JEONG, Seoul (KR); Gwanghee CHO, Seoul (KR)

(21) Appl. No.: 19/271,320

(22) Filed: Jul. 16, 2025

(30) Foreign Application Priority Data
Jul. 18, 2024 (KR) 10-2024-0094828

(51) Int. Cl. C02F 1/469

(52) U.S. Cl. CPC C02F 1/4691; C02F 2201/46

(57) ABSTRACT

Provided is a method for manufacturing an organic solvent-free capacitive deionization electrode including: coating one surface or one and the other surfaces of a current collector with an active layer slurry including an electrode active material, an aqueous binder, a dispersant, and an aqueous solvent; drying the active layer slurry; combining the dried active layer and an ion exchange membrane using an adhesive including a porous material and the aqueous binder; and drying an electrode in which the active layer and the ion exchange membrane are combined.

### CROSS-REFERENCE TO RELATED APPLICATIONS

This application claims priority under 35 U.S.C. § 119 to Korean Patent Application No. 10-2024-0094828, filed on Jul. 18, 2024, in the Korean Intellectual Property Office, the disclosure of which is incorporated herein by reference in its entirety.

### TECHNICAL FIELD

The following disclosure relates to a capacitive deionization electrode and a method for manufacturing the same, and more particularly, to a method for manufacturing a capacitive deionization electrode using an adhesive including a porous material and an aqueous binder.

### BACKGROUND

A deionization technology is a technology for removing ionic materials included in a fluid, and may remove harmful substances such as heavy metals, nitrate nitrogen, and fluoride ions included in domestic and industrial water or contaminants related to process efficiency and product performance. In addition to that, since it may be used in various fields such as manufacture of ultrapure water from which ionic materials have been completely removed in medical and electronic industries or a desalination method of seawater, it is a technology in the spotlight.

As a deionization method, an ion exchange method using an ion exchange resin is generally mainly used. An ion exchange resin may effectively separate ionic materials in an aqueous solution, but in a process of regenerating the ion exchanged ions, large amounts of acids, bases, or a salt waste liquid are produced. In addition to that, there is a deionization method using a separator technology such as reverse osmosis and electrodialysis, but it has various problems such as a functional decline of membranes due to a fouling phenomenon such as adsorption of contaminants or pore blockage.

Recently, a capacitive deionization (CDI) technology for solving the disadvantages has been developed, and the capacitive deionization technology is a technology of adsorbing ions by electrical attraction using a principle of formation of an electric double layer on the surface of an electrode when applying an electric potential. Since the technology may be operated at a low electrode potential, significantly less energy is consumed than other technologies, and thus, it is attracting worldwide attention.

A capacitive deionization electrode may be manufactured by coating an ion exchange solution having ion selectivity or attaching an ion exchange membrane in order to form an ion exchange layer on an electrode. In addition that, a deionization electrode requiring separate assembly with a flow path allowing a fluid to flow between electrodes has a complicated manufacturing process, and automation of the process is difficult.

In addition, an organic solvent such as N-methyl-2-pyrrolidone (NMP) and dimethylacetamide (DMAC) is used as an adhesive in the process of combining the ion exchange membrane with an electrode. Since the organic solvent is very toxic to the human body and the environment, it should be necessarily treated for recovery in the process of manufacturing a deionization electrode. Therefore, a method for manufacturing an electrode which may show excellent deionization performance without using the organic solvent is required, and a method for manufacturing a deionization electrode more easily in a continuous process is needed.

### SUMMARY

An embodiment of the present disclosure is directed to providing an organic solvent-free capacitive deionization electrode. More specifically, a capacitive deionization electrode which has identically excellent deionization performance may be manufactured without using an adhesive including an organic solvent such as N-methyl-2-pyrrolidone (NMP) and dimethylacetamide (DMAC).

Another embodiment of the present disclosure is directed to providing a capacitive deionization electrode having excellent deionization performance using an adhesive including a porous material and an aqueous binder.

In one general aspect, a method for manufacturing an organic solvent-free capacitive deionization electrode includes: coating one surface or one and the other surfaces of a current collector with an active layer slurry including an electrode active material, an aqueous binder, a dispersant, and an aqueous solvent; drying the active layer slurry; combining the dried active layer and an ion exchange membrane using an adhesive including a porous material, an aqueous binder, and an aqueous solvent; and drying an electrode in which the active layer and the ion exchange membrane are combined.

In an exemplary embodiment, the porous material is a conductive porous material and may be any one or more selected from active carbon, graphene, aerosol, carbon nanotubes, metal organic framework, polypyrrole, and polyaniline.

In an exemplary embodiment, the aqueous binder may be any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA).

In an exemplary embodiment, the adhesive may include 20 to 70 wt % of the porous material.

In an exemplary embodiment, the adhesive may include 30 to 80 parts by weight of the aqueous binder based on 100 parts by weight of the porous material.

In an exemplary embodiment, the adhesive may include 50 to 100 parts by weight of the aqueous solvent based on 100 parts by weight of the porous material.

In an exemplary embodiment, the active layer slurry may be dried so that 95 wt % or more of the aqueous solvent based on the weight of the aqueous solvent included in the slurry is removed.

In an exemplary embodiment, the combined electrode may be dried at a temperature of 20 to 80° C.

In an exemplary embodiment, the combined electrode may be dried so that 80 wt % or more of the aqueous solvent based on the weight of the aqueous solvent included in the adhesive is removed.

In an exemplary embodiment, the combining step may use a laminating combining method.

In an exemplary embodiment, the one surface or the one or the other surfaces of the current collector may be coated with the slurry using any one or more coating methods selected from comma, gravure, knife casting, doctor blade, and die coating.

In another general aspect, an organic solvent-free capacitive deionization electrode includes: an active layer including an electrode active material, an aqueous binder, and a dispersant, which is formed on one surface or one and the other surfaces of a current collector; an adhesive layer including a porous material and an aqueous binder, which is formed on the active layer; and any one or more ion exchange membranes selected from a cation exchange membrane and an anion exchange membrane, which is formed on the adhesive layer.

In an exemplary embodiment, the porous material is a conductive porous material and may be any one or more selected from active carbon, graphene, aerosol, carbon nanotubes, metal organic framework, polypyrrole, and polyaniline.

In an exemplary embodiment, the aqueous binder may be any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA).

Other features and aspects will be apparent from the following detailed description, the drawings, and the claims.

### BRIEF DESCRIPTION OF THE DRAWINGS

FIG. 1 is a graph showing TDS changes of Example 1 and Comparative Examples 1 to 3 over time.

FIG. 2 is a graph showing a TDS change of Comparative Example 1 for a long time under an influent water condition of 500 mg/L NaCl.

FIG. 3 is a graph showing a TDS change of Example 1 for a long time under an influent water condition of 500 mg/L NaCl.

FIG. 4 is a graph showing a TDS change of Comparative Example 2 for a long time under an influent water condition of 250 mg/L NaCl.

### DETAILED DESCRIPTION OF EMBODIMENTS

Hereinafter, an organic solvent-free capacitive deionization electrode and a method for manufacturing the same of the present disclosure will be described in detail. However, it is only illustrative, and the present disclosure is not limited to the specific embodiments which are illustratively described in the present disclosure.

The terms used in the present disclosure are selected to be as common as possible and are currently widely used while considering the function of the present disclosure, but they may vary depending on the intention of a person skilled in the art, the precedent, the emergence of new technology, or the like. The technical and scientific terms used may have, unless otherwise defined, the meaning commonly understood by those with ordinary skill in the art to which the present disclosure pertains.

The terms such as “comprise” or “have” in the present disclosure and the claims mean that there is a characteristic or a constitutional element described in the specification, and as long as it is not particularly limited, a possibility of adding one or more other characteristics or constitutional elements is not excluded.

A singular expression in the present disclosure and the claims includes a plural expression, unless otherwise explicitly specified as singular. In addition, a plural expression includes a singular expression, unless otherwise explicitly specified as plural.

In addition, the numerical range used in the present disclosure includes all values within the range including the lower limit and the upper limit, increments logically derived in a form and span of a defined range, all double limited values, and all possible combinations of the upper limit and the lower limit in the numerical range defined in different forms. Unless otherwise defined in the present disclosure, values which may be outside a numerical range due to experimental error or rounding off of a value are also included in the defined numerical range.

The term of degree “about” and the like used in the present disclosure and the claims are used in the sense of covering an allowable error when the allowable error exists.

The method for manufacturing an organic solvent-free capacitive deionization electrode according to the present disclosure includes: coating one surface or one and the other surfaces of a current collector with an active layer slurry including an electrode active material, an aqueous binder, a dispersant, and an aqueous solvent; drying the active layer slurry; combining the dried active layer and an ion exchange membrane using an adhesive including a porous material, an aqueous binder, and an aqueous solvent; and drying an electrode in which the active layer and the ion exchange membrane are combined.

The manufacturing method is a method for manufacturing an organic solvent-free capacitive deionization electrode using an adhesive which does not include an organic solvent such as N-Methyl-2-pyrrolidone (NMP), dimethylacetamide (DMAC), dimethylformamide, chloroform, dichloromethane, and trichloroethylene. The organic solvent is an adhesive for combining an active layer and an ion exchange membrane of an electrode in the manufacture of the capacitive deionization electrode and is used mainly after being mixed with a binder. Since the organic solvent such as NMP and DMAC is highly toxic, it should be necessarily treated for recovery.

As an example, conventionally, an adhesive in which a synthetic resin or a rubber is dispersed in the organic solvent was used, for example, by dispersing polyvinylidene fluoride (PVDF) as a binder in NMP. However, the manufacturing method according to the present disclosure may produce an organic solvent-free capacitive deionization electrode, by using an adhesive including a porous material and an aqueous binder instead of an adhesive including an organic solvent, as well as producing the active layer slurry including an aqueous solvent and an aqueous binder. Simultaneously, the manufacturing method according to the present disclosure may produce a deionization electrode which shows excellent deionization performance and performance maintenance ability at the same or a similar level as before, while using the environmentally friendly adhesive. Also, the manufacturing method of the present disclosure may effectively evaporate the aqueous solvent to increase the conductivity of the deionization electrode, by including an active layer slurry drying step; and a series of drying steps including a combined electrode.

In an exemplary embodiment, the manufacturing method may produce a deionization electrode by including a step of combining each active layer of an electrode in which the active layer has been formed on one surface or one and the other surfaces of a current collector and an ion exchange membrane. Preferably, the electrode in which the active layer and the ion exchange membrane are formed on one and the other surfaces of the current collector may have decreased bending due to shrinkage.

As an example of the manufactured deionization electrode, an electrode in which a cation or anion exchange membrane is combined with the active layer on one surface of the current collector may be formed. As another example, a cation exchange membrane and an anion exchange membrane may be combined with an active layer on one and the other surfaces of the current collector, respectively to form a bipolar CDI electrode, or a CDI electrode in which the same kind of ion exchange membranes of the cation or anion exchange membrane are combined on one and the other surfaces may be laminated to form a CDI composite electrode structure.

In an exemplary embodiment, the current collector may include any one or more selected from the group consisting of aluminum, nickel, copper, titanium, cobalt, iron, and graphite, and the form may be a sheet, a thin film, or a plain-woven wire mesh. In addition, it is preferred that the current collector has excellent conductivity, since an electric field is uniformly formed. As an example, it is preferred that the current collector is a graphite foil, since it may perform a roll to roll manufacturing process while showing excellent conductivity.

In an exemplary embodiment, the active layer slurry does not include an organic solvent, and the aqueous solvent included in the slurry may be any one or more solvents selected from water and alcohol-based solvents. Preferably, it may be water.

In an exemplary embodiment, the aqueous solvent may be included at 60 to 80 wt % of the total weight of the active layer slurry. Specifically, it may correspond to 60 to 80 wt %, 60 to 70 wt %, 70 to 80 wt %, 65 to 80 wt %, 65 to 75 wt %, or a value between the numerical ranges. Without being necessarily limited to the numerical ranges, when the aqueous solvent is included at the above content, the dispersion degree of an electrode active material and a binder and the slurry viscosity in a coating step may be appropriate, and it may be the most efficient and effective for removing the aqueous solvent by evaporation in a slurry drying step. When too much aqueous solvent is included, a drying temperature should be increased or a drying time may be increased, and when too little aqueous solvent is included, dispersion may be insufficient or it may not be easy to coat the current collector with the slurry.

In addition, in an exemplary embodiment, the slurry may include any one or more selected from active carbon, carbon nanotubes, carbon aerogel, and metal oxides, as an electrode active material. The metal oxide may include any one or more selected from SiO₂, RuO₂, Ni(OH)₂, MnO₂, PbO₂, TiO₂, and the like, as an example. The electrode active material may be a porous material.

A carbon electrode including a porous carbon material and an active material may be preferred for its large surface area and low reactivity, and preferably, an active carbon electrode in which the current collector is coated with an active layer slurry including the active carbon as an electrode active material may be used. In particular, the active carbon may have benefits of high desorption-adsorption performance and long lifespan as well as excellent pore volume and specific surface area. Therefore, when the active carbon electrode is combined with an ion exchange membrane to manufacture a CDI electrode, electrode performance may be excellent, which may be thus preferred.

As an example, it may be using a graphite foil as the current collector and coating the upper and lower surfaces of the foil with an active layer slurry including a carbon material, more specifically, an active layer slurry including active carbon.

In an exemplary embodiment, the electrode active material may be included at 20 to 60 parts by weight with respect to 100 parts by weight of the aqueous solvent. Specifically, it may correspond to 20 to 60 parts by weight, 20 to 50 parts by weight, 20 to 40 parts by weight, 30 to 60 parts by weight, 30 to 50 parts by weight, 35 to 45 parts by weight, or a value between the numerical ranges. Though it is not limited as long as the physical properties of the deionization electrode according to the present disclosure are achieved, when the electrode active material is included at the above content, the conductivity of the active layer may be excellent and the dispersion and coating of the slurry may be easy.

In an exemplary embodiment, the aqueous binder included in the slurry may be any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA).

The binder is added for strengthening electrical connection and binding force between the current collector and the active material of the active layer and between active material particles, and preferably, the aqueous binder may be included at 10 to 30 parts by weight with respect to 100 parts by weight of the electrode active material. The weight of the aqueous binder may refer to the weight as a solid content. Though it is not limited as long as the physical properties of the deionization electrode according to the present disclosure are achieved, when the aqueous binder is included in the content range, a binding force is excellent without reducing the conductivity of the active layer, and the viscosity of the slurry is appropriate, which is thus preferred.

In an exemplary embodiment, the dispersant included in the slurry may be any one or more selected from carboxymethyl cellulose (CMC), polyvinyl alcohol (PVA), and polyacrylic acid (PAA). In addition, the dispersant is added for uniform dispersion of the active material particles and the binder of the active layer slurry, and preferably, the dispersant may be included at 0.1 to 10 parts by weight, preferably 1 to 5 parts by weight with respect to 100 parts by weight of the electrode active material. Though it is not limited as long as the physical properties of the deionization electrode according to the present disclosure are achieved, a dispersion effect is appropriate and there is no reduction in durability due to bubble generation within the content range, which may be thus preferred.

In an exemplary embodiment, the polymer of the binder and the dispersant may have a weight average molecular weight of 10,000 to 4,000,000 g/mol or a value between the numerical range, preferably 10,000 to 2,000,000 g/mol, 10,000 to 1,500,000 g/mol, or 10,000 to 1,000,000 g/mol. It may be preferred for the viscosity and the binding force of the active layer slurry to use a polymer having the weight average molecular weight in the above range.

In addition, in an exemplary embodiment, the active layer slurry may have a viscosity of 800 to 2000 cP. The viscosity may be specifically 800 cP or more, 900 cP or more, 1000 cP or more and 2000 cP or less, 1900 cP or less, 1800 cP or less, 1700 cP or less, 1600 cP or less, or a value between the numerical values. Preferably, the viscosity may be 1000 to 1500 cP, 1100 to 1500 cP, more preferably 1200 to 1400 cP.

Within the viscosity, the slurry may be uniformly dispersed and coated on the surface of the current collector, and the aqueous solvent may be included at the content which may be effectively removed in a drying step, which may be thus preferred. When too much aqueous solvent is included in the slurry and the active layer is insufficiently dried, the conductivity of the manufactured CDI may be decreased, and the drying time and energy required for removal of the solvent are increased, which may be inefficient. However, the viscosity of the slurry may have a value out of the numerical range depending on a coating process.

In an exemplary embodiment, the active layer may be coated using any one or more coating methods selected from comma coating, gravure coating, knife casting, doctor blade, and die coating. The active layer slurry may be coated sequentially or simultaneously on one surface or the other surface of the current collector, and in particular, when coating methods of comma and gravure are used, the active layer is simultaneously formed on one and the other surface, that is, both surfaces of the current collector to increase process efficiency, which may be thus preferred. However, the coating method is not necessarily limited thereto, and any coating method which may satisfy the physical properties of the deionization electrode manufactured according to the present disclosure, such as dip coating, spin coating, and spraying, may be used.

As an example, coating with the active layer slurry may be performed once or repeated twice or more, and the thickness of the coated active layer may be 50 to 300 μm. Specifically, the thickness may be 50 to 250 μm, 100 to 300 μm, 150 to 250 μm, or 150 to 300 μm. Though it is not necessarily limited thereto, when the active layer has the thickness, deionization performance may be improved while resistance of the electrode is decreased, which may be thus appropriate.

In an exemplary embodiment, in a step of drying the active layer slurry coated on the current collector, the aqueous solvent included in the slurry may be evaporated. The active layer slurry may be dried so that 95 wt % or more of the aqueous solvent based on the weight of the aqueous solvent included in the slurry is removed. Specifically, 95 wt % or more, 98 wt % or more, preferably 99 wt % or more of the aqueous solvent based on the weight of the aqueous solvent included in the slurry may be removed. This may be a calculated value, assuming that a weight difference before and after drying is all caused by the weight loss from solvent evaporation of the active layer slurry. By drying the active layer as such, the manufacturing method of the present disclosure improves contact between the active layer and the current collector, and between the adhesive and the ion exchange membrane combined by the adhesive, and the conductivity of the manufactured deionization electrode may be improved.

Specifically, the aqueous binder of the active layer slurry is a non-conductive material, and the binder of the active layer is in surface contact with the adhesive and the ion exchange membrane due to the undried aqueous solvent, so that the conductivity of the manufactured deionization electrode may be decreased. However, when the aqueous solvent included in the active layer slurry is evaporated by the drying process, the binder of the active layer is in surface contact with the adhesive and the ion exchange membrane, thereby improving the conductivity of the manufactured deionization electrode. Also, the aqueous solvent included in the active layer is not sufficiently removed only by combining the active layer and the ion exchange membrane and then drying, which may be thus not preferred. Therefore, the manufacturing method of the present disclosure may produce a deionization electrode having excellent performance by including drying an active layer slurry; combining; and drying the combined electrode in combination.

In an exemplary embodiment, the drying of the slurry may be performed by a drying method of hot air drying, infrared drying, vacuum drying, atmospheric pressure drying, or a combination thereof.

As an example, the hot air drying may be performed at a temperature of 50 to 120° C., more specifically, 50 to 100° C., 60 to 120° C., 60 to 100° C., 70 to 120° C., 70 to 110° C., 70 to 100° C., preferably 80 to 100° C., or a temperature between the numerical ranges.

In addition, as an example, the infrared drying may be performed by irradiation with infrared rays corresponding to a wavelength of 700 nm to 6 μm at a voltage of 50 to 100 V. Preferably, it may be preferred to perform drying by irradiation with infrared rays having a wavelength corresponding to 700 nm to 5 μm, 700 nm to 3 μm, 700 nm to 1 μm, or a value between the numerical ranges, since only water molecules may be selectively heated and evaporated.

In addition, as an example, the drying time of the slurry may be a total of 1 to 12 hours.

However, the drying process and the conditions are not necessarily limited as described above, and it is not limited as long as the active layer is sufficiently dried and the physical properties of the manufactured deionization electrode are maintained.

In an exemplary embodiment, the manufacturing method of the present disclosure may further include compressing after drying the active layer slurry. As a non-limiting example, the compression may be performed at a pressure of 400 to 500 bar, through a roll press. In addition, the compression may be performed simultaneously with heating. By including the compression step, a more robust electrode may be manufactured. However, as long as the physical properties of the manufactured deionization electrode are maintained, the compression may be performed by other pressure or methods out of the ranges described above.

Next, in an exemplary embodiment, the ion exchange membrane may be obtained by coating one or more surfaces of an ion exchange membrane substrate with a cation exchange solution or an anion exchange solution and drying and may be used after direct manufacture or purchase of a commercial product.

In addition, in the manufacturing method of the present disclosure, by combining the active layer and the ion exchange membrane formed on both surfaces of the current collector, a deionization electrode in which ion exchange membranes having the same or different polarity are combined on both surfaces of the electrode may be manufactured. Thus, the method for manufacturing a deionization electrode according to the present disclosure allows maintenance of a stable form without bending which occurs in a single ion exchange membrane, and it may be easy to form a structure by laminating a plurality of deionization electrodes or laminating a positive electrode, a negative electrode, a current collector, and the like on the deionization electrode.

The ion exchange membrane may be, as an example, a flow path-integrated ion exchange membrane, and may be a flow path-integrated ion exchange membrane in which a flow path pattern is formed on the opposite surface to the surface combined with the active layer. When the flow path is integrally formed, a spacer is not separately needed, and thus, convenience and production efficiency of a manufacturing process may be increased.

In an exemplary embodiment, the substrate may be any one or more selected from sheets, thin films, woven fabric, or nonwoven fabric including a polymer fiber, a natural fiber, or a combination thereof. In addition, the polymer fiber may be formed of any one or more polymers selected from the group consisting of polyamide series, polyethylene series, polypropylene series, cellulose series, polyacryl series, polyvinyl chloride (PVC), polyvinyl alcohol (PVA), and polyester series, but is not necessarily limited thereto as long as the physical properties of the manufactured deionization electrode are satisfied.

In addition, in an exemplary embodiment, a cation exchange solution may include any one or more cation exchange groups selected from a sulfonic acid group, a carboxyl group, a phosphonic group, a phosphinic group, an arsonic group, and a selenonic acid, and an anion exchange solution may include any one or more anion exchange group selected from primary amine salts, secondary amine salts, tertiary amine salts, quaternary ammonium salts, a quaternary phosphonium group, and a tertiary sulfonium group.

The ion exchange solution may be prepared by mixing a polymer resin including the cation exchange group or the anion exchange group as described above with a soluble solvent. The solvent may be any solvent which allows manufacture of the ion exchange membrane by dissolving the polymer resin, and as an example, an organic solvent may be used. However, the organic solvent may be removed in a drying process of the ion exchange membrane and may be completely removed.

The content of the polymer resin having an ion exchange group may be 1 to 30 wt %, specifically 1 to 30 wt %, 1 to 20 wt %, 5 to 30 wt %, 5 to 20 wt %, 5 to 15 wt % of the ion exchange solution, or a value between the numerical ranges. Within the range, it is easy to adjust the thickness of the ion exchange membrane and secure a flow path, and the solvent included in the ion exchange solution is evaporated in the drying process, which may be thus preferred.

As an example, the ion exchange solution may have a viscosity of 100 to 500 cP at 20 to 30° C. It may be preferred to use the ion exchange solution having the viscosity for uniform coating of the substrate with the ion exchange solution and drying of the solvent, but is not limited as long as the performance of the ion exchange membrane is maintained.

The ion exchange solution may be coated on one surface of the substrate by any one or more selected from casting, spraying, dip coating, knife coating, doctor blade, die coating, and spin coating, but is not necessarily limited thereto as long as the physical properties of the ion exchange membrane are achieved.

In addition, the ion exchange membrane may be dried after immersing the substrate in the ion exchange solution. A drying method may be hot air drying, infrared drying, vacuum drying, or a combination thereof, but is not necessarily limited thereto. In addition, a drying temperature may be preferably 20 to 70° C., since the physical properties of the ion exchange membrane are not changed at the temperature.

In an exemplary embodiment, the thickness of the ion exchange membrane may be 10 to 100 μm, and within the thickness range, the resistance degree and the deionization efficiency of the ion exchange membrane may be preferred, but is not necessarily limited thereto.

Hereinafter, a combining step of the dried active layer and the ion exchange membrane will be described.

As described above, in the manufacturing method according to the present disclosure, the dried active layer may be combined with the ion exchange membrane using an adhesive. The adhesive includes a porous material with the aqueous binder, thereby increasing an adhesion effect while allowing anions and cations to pass well, so that the manufactured CDI electrode may have excellent deionization performance.

This is not allowed only with an adhesive including only the aqueous binder, and specifically, when the active layer and the ion exchange membrane are combined only using the aqueous binder, a thin film is formed on the surface of the ion exchange membrane and acts as a resistor to cause performance degradation. That is, the CDI electrode manufactured with an adhesive including only the aqueous binder may satisfy deionization performance initially, but as an operation time increases, rapid performance degradation from the resistor may occur. However, the manufacturing method of the present disclosure uses the adhesive including the aqueous binder and the porous material in a mixed form, so that the porous material suppresses film formation, thereby solving the performance degradation problem.

In an exemplary embodiment, the porous material included in the adhesive may be a conductive porous material and may be any one or more selected from active carbon, graphene, aerosol, carbon nanotubes, metal organic framework, polypyrrole, and polyaniline. In addition, the adhesive may include other porous polymers conductive other than polypyrrole and polyaniline.

In an exemplary embodiment, the adhesive may include 20 to 70 wt % of the porous material. Specifically, the porous material may be included at 20 to 70 wt %, 20 to 60 wt %, 20 to 50 wt %, 30 to 70 wt %, 30 to 60 wt %, or a value between the numerical ranges. Preferably, the porous material may be included at 30 to 50 wt %. When the porous material is included within the range, it may be preferred for suppressing formation of a resistor film with the ion exchange membrane without reduction in conductivity of the electrode due to the adhesive.

In addition, in an exemplary embodiment, the aqueous binder included in the adhesive may be any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA). The aqueous binder may be the same as or different from the aqueous binder included in the active layer described above.

In an exemplary embodiment, the adhesive may include 30 to 80 parts by weight of the aqueous binder based on 100 parts by weight of the porous material. Specifically, the aqueous binder may be included at 30 to 80 parts by weight, 30 to 70 parts by weight, 30 to 60 parts by weight, 40 to 80 parts by weight, 40 to 70 parts by weight, 40 to 60 parts by weight, or a value between the numerical ranges. Preferably, the aqueous binder may be included at 40 to 70 parts by weight. When the aqueous binder is included at the content described above, adhesive strength between the active layer and the ion exchange membrane may be excellent while formation of a resistor film from the adhesive and the ion exchange membrane may be minimized, which may be thus preferred. The weight of the aqueous binder may refer to the weight as a solid content.

In an exemplary embodiment, the adhesive may include 50 to 100 parts by weight of the aqueous solvent based on 100 parts by weight of the porous material. Specifically, the aqueous solvent may be included at 50 to 100 parts by weight, 50 to 90 parts by weight, 60 to 100 parts by weight, 70 to 100 parts by weight, 70 to 90 parts by weight, 80 to 100 parts by weight, or a value between the numerical ranges. The aqueous solvent may be included for dispersion of the porous material and the aqueous binder and may be removed by evaporation in the process of drying the combined electrode. When the aqueous solvent is dried, the aqueous binder of the adhesive is in point contact with the active layer and the ion exchange membrane to improve the conductivity of the manufactured electrode. When the aqueous solvent is included at the above content, dispersion of the porous material and the aqueous binder included in the adhesive may be appropriately performed while the solvent may be effectively dried, which may be thus preferred. When excessive aqueous solvent is included, the solvent may not be sufficiently removed in the drying process or drying efficiency may not be good, and when included too little, it may be not easy to disperse the porous material and the aqueous binder and apply the adhesive.

In an exemplary embodiment, the adhesive in the combining step may be, as an example, applied at a thickness of 100 μm or less. Without being necessarily limited to the thickness, when the adhesive is applied at the thickness of 100 μm or less, the conductivity of the electrode is not impaired due to the adhesive while the adhesive strength is excellent, which may be thus preferred.

In an exemplary embodiment, the combining step may use a laminating combining method. In addition, the laminating process may be performed by one selected from cold laminating or hot laminating.

In an exemplary embodiment, compressing before or after drying the combined electrode may be further included, and the compression may be performed by a roll press. In addition, the compression may be performed simultaneously with heating. Thus, a more robust electrode may be manufactured and the compression may be performed by a method other than the roll press method as long as the physical properties of the manufactured deionization electrode are maintained.

In an exemplary embodiment, cutting the combined electrode before the drying step may be further included. In order to prevent deformation of the electrode in the drying process, the electrode may be cut into an appropriate size, wound in a roll shape, and then dried. As a non-limiting example, the roll may be cut into a form having an outer diameter of 200 mm and an inner diameter of 24 mm.

The combined electrode is dried for removing moisture included in the adhesive, and in an exemplary embodiment, the combined electrode may be dried at a temperature of 20 to 80° C. Specifically, the drying may be performed at a temperature of 20 to 80° C., 30 to 80° C., 20 to 70° C., 20 to 60° C., 30 to 70° C., 30 to 60° C., 35 to 55° C., or a value between the numerical ranges. The drying at the temperature may be performed by hot air drying, vacuum drying, or atmospheric pressure drying, and may be performed at a temperature out of the temperature range as long as the physical properties of the electrode are maintained, and the drying time may be different depending on the drying conditions.

80 wt % or more of the aqueous solvent based on the weight of the aqueous solvent included in the adhesive may be removed from the combined electrode. Specifically, the drying may be performed so that 80 wt % or more, 85 wt % or more, 90 wt % or more, preferably 95 wt % of the aqueous solvent is removed. This may be calculated from the weight difference and the weight of the aqueous solvent included in the adhesive used in the combining, assuming that the weight difference before and after drying of the combined electrode is all caused by the weight loss from the solvent evaporation. This may be a calculated value, assuming that a weight difference before and after drying is all caused by the weight loss from evaporation of the aqueous solvent in the adhesive.

By drying the combined electrode as such, the manufacturing method of the present disclosure improves contact of the adhesive with the active layer and the ion exchange membrane combined therefrom, so that the conductivity of the manufactured deionization electrode may be improved. That is, by removing a large amount of aqueous solvent in the adhesive by drying as described above, surface contact of the binder due to the aqueous solvent is decreased and the active layer and the ion exchange membrane are in point contact to improve the conductivity of the electrode and show excellent adhesive strength.

In another exemplary embodiment, an organic solvent-free capacitive deionization electrode includes: an active layer including an electrode active material, an aqueous binder, and a dispersant, which is formed on one surface or one and the other surfaces of a current collector; an adhesive layer including a porous material and an aqueous binder, which is formed on the active layer; and any one or more ion exchange membranes selected from a cation exchange membrane and an anion exchange membrane, which is formed on the adhesive layer.

The deionization electrode as such may be the same as or similar to the deionization electrode manufactured from the manufacturing method described above, and the omitted deionization electrode may show, in an exemplary embodiment, the same configuration and physical properties as described above in the manufacturing method.

In an exemplary embodiment, as described above, the porous material may be a conductive porous material and may be any one or more selected from active carbon, graphene, aerosol, carbon nanotubes, metal organic framework, polypyrrole, and polyaniline. In addition, the adhesive may include other porous conductive polymers other than polypyrrole and polyaniline.

In an exemplary embodiment, as described above, the aqueous binder may be any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA).

As such, since the deionization electrode shows a structure in which the ion exchange membrane and the active layer are attached by the adhesive layer including the aqueous solvent and the aqueous binder without including an organic solvent, an environmentally friendly deionization electrode may be provided without outflow of the organic solvent. In addition, since the adhesive layer shows excellent adhesive strength without conductivity resistance of the electrode, it may have excellent deionization performance at the same or a similar level of the conventional deionization electrode using an organic solvent.

In an exemplary embodiment, the deionization electrode described above may form an organic solvent-free capacitive deionization electrode structure by laminating a plurality of the electrodes. As an example, a plurality of electrodes including both electrodes of anion and cation exchange membranes may be laminated or a CDI electrode in which the same kind of ion exchange membranes are combined may be laminated to form a CDI composite electrode structure. The composite electrode structure as such may act as a single cell used in the deionization reaction or may be included in a single cell.

Hereinafter, the examples of the present invention will be further described with reference to the specific experimental examples. It is apparent to those skilled in the art that the examples and the comparative examples included in the experimental examples only illustrate the present invention and do not limit the appended claims, and various modifications and alterations of the examples may be made within the range of the scope and spirit of the present invention, and these modifications and alterations will fall within the appended claims.

### Preparation Example 1

A mixture including 25.4 wt % of active carbon powder, 5.1 wt % of styrene butadiene rubber (SBR) powder, 0.5 wt % of carboxymethyl cellulose sodium salt (CMC) powder, and a remaining of water was stirred at a dispersion speed of 1000 to 3000 RPM for 180 minutes to prepare an active layer slurry having a viscosity of about 1300 cP. A graphite foil in a roll form was wound, and the upper and lower portions of the foil were coated with the slurry prepared by knife casting using a comma roll coater at a thickness of 200 μm, respectively. The coated slurry was dried by applying hot air at 90° C. and infrared rays under a voltage of 70 V, and roll pressed with a pressure of 450 bar to manufacture a carbon electrode in which an active layer was formed on both surfaces of the graphite foil.

Next, a composition including 41.6 wt % of active carbon powder and a remaining of SBR aqueous solution (including SBR at a concentration of 40 wt %) was mixed and dispersed to prepare an adhesive. Thereafter, the adhesive was applied at a thickness of about 50 μm between the active layer and the ion exchange membrane of the carbon electrode to combine them in a laminating combining manner. As the ion exchange membrane, a cation exchange membrane and an anion exchange membrane, which were manufactured by immersing one surface of a PE film in each of a cation exchange solution and an anion exchange solution and drying, were used. Specifically, the combining was performed so that the active layer formed on the upper portion of the current collector and the immersed surface of the cation exchange membrane were in contact with each other and the active layer formed on the lower portion of the current collector and the immersed surface of the anion exchange membrane were in contact with each other.

The combined electrode was wound in a roll shape and cut, and then dried in a vacuum oven at 40° C. for 3 hours to complete a CDI electrode.

### Example 1

The same adhesive, carbon electrode, and ion exchange membrane as Preparation Example 1 were used to manufacture a negative electrode in which a cation exchange membrane was combined with one surface of the carbon electrode and a positive electrode in which an anion exchange membrane was combined with one surface of the carbon electrode.

The positive electrode, the negative electrode, and the CDI electrode of Preparation Example 1 were cut into a size of 10×10 cm², lamination was performed so that the cation exchange membrane on the negative electrode and the anion exchange membrane of the CDI electrode face each other and the anion exchange membrane on the positive electrode and the cation exchange membrane of the CDI electrode face each other, and in order to provide a flow path, a Nylon-6, 100 mesh having a thickness of 100 μm was inserted between the electrodes to configure a CDI composite electrode.

An externally applied current collector electrode was laminated on the positive electrode and the negative electrode to manufacture a CDI composite electrode cell, and placed between acryl capable of supplying with pressure and water to manufacture a CDI composite electrode single cell. At this time, a hole having a diameter of 1 cm was pierced in the center of the composite electrode so that raw water was inflowed from the outside of the electrode and discharged through the flow path.

### [Comparative Example 1] NMP

A CDI composite electrode single cell was manufactured in the same manner as in Preparation Example 1 and Example 1, except that the combining was performed using a N-methyl-2-pyrrolidone (NMP) solution in which polyvinylidene fluoride (PVDF) was mixed and dispersed at a concentration of 3 wt % as the adhesive.

### [Comparative Example 2] Using Only SBR

A CDI composite electrode single cell was manufactured in the same manner as in Preparation Example 1 and Example 1, except that the combining was performed using an adhesive formed of only an SBR aqueous solution (including SBR at a concentration of 40 wt %).

### [Comparative Example 3] Undried Combined Electrode

A CDI composite electrode single cell was manufactured in the same manner as in Preparation Example 1 and Example 1, except that the CDI electrode, the positive electrode, and the negative electrode were not dried after combining the carbon electrode and the ion exchange membrane.

### [Comparative Example 4] Undried Active Layer

A CDI composite electrode single cell was manufactured in the same manner as in Preparation Example 1 and Example 1, except that the CDI electrode, the positive electrode, and the negative electrode were combined with the ion exchange membrane directly on the carbon electrode on which the coated active layer slurry was not dried.

### [Evaluation Method]

### 1. Measurement of Weight Change

While Preparation Example 1 was performed, the weights before and after drying the coated active layer slurry and the weights before and after drying of the electrode combined with the ion exchange membrane were measured. The lost weight means how much water or NMP has been removed in the drying process of the active layer slurry or the combined CDI electrode, and the measurement results are shown in Tables 1 and 2.

### 2. Deionization Rate Test

The deionization performance of the manufactured CDI composite electrode unit cell was performed under the conditions of supplying 500 mg/L of NaCl solution at a speed of 100 mL/min to raw water while 3.0 V of electrode potential was constantly applied to the current collector electrode. In addition, operation was performed in the order of adsorption for 90 seconds and desorption for 90 seconds at reverse potential, and deionization and regeneration were repeated.

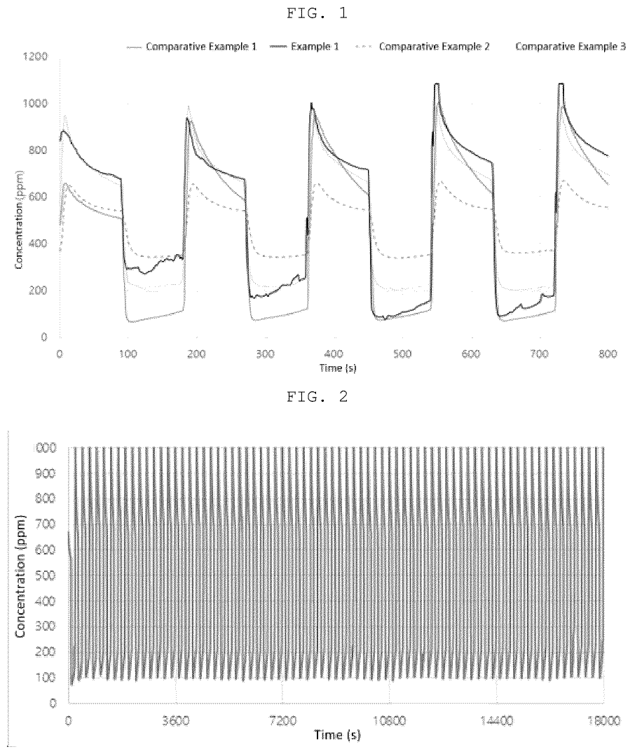

The deionization rate was calculated by measuring a change in a total dissolved solid (TDS) of the deionized effluent water by a TDS meter (CCT-3300). The calculated deionization rates are shown in the following Tables 1 and 2, and the TDS changes over time are shown in FIG. 1.

### 3. Maintenance Ability Test

Deionization and regeneration were repeated under the same conditions as the deionization rate test described above, and it was confirmed whether the manufactured CDI electrode unit cell was able to maintain the performance for a long time. However, the maintenance ability test of Comparative Example 2 was performed by changing the conditions to low concentration conditions of supplying the 250 mg/L of the NaCl solution at a speed of 100 mL/min. As a result, TDS graphs for about 18000 seconds were shown in FIGS. 2 to 4, and it was evaluated whether the deionization rate calculated therefrom was constantly maintained.

Hereinafter, the results of testing Preparation Example 1, Example 1, and the Comparative Examples according to the evaluation methods described above will be described.

The results of weight change measurement and the deionization rate test are shown in FIG. 1 and the following Tables 1 and 2.

First, the deionization rates calculated from the TDS change values over time under the conditions of 500 mg/L of a NaCl solution of FIG. 1 were compared as shown in Table 1. As a result, Example 1 showed a deionization rate of 77.32%, which is almost the same level of deionization rate of 77.68% of Comparative Example 1 using the conventional adhesive including an NMP solvent. However, Comparative Example 2 using an SBR aqueous solution as the adhesive showed a deionization rate of 31.10%, which was significantly lower than that of the example, and Comparative Example 3 in which the combined electrode was not dried showed a deionization rate of 53.11%. In addition, though not shown in the drawings, as a result of comparing the deionization rates of Example 1 and Comparative Example 4, Comparative Example 4 in which the active layer was not dried showed a deionization rate of 50.21%, which was significantly lower than that of Example 1. Thus, it was confirmed therefrom that the manufacturing method according to the present disclosure further improves the deionization electrode performance, from the step of removing the solvent by drying the active layer slurry.

Next, in the following Table 2, as a result of measuring a weight change of the carbon electrode before and after the active layer slurry of Preparation Example 1, a weight decrease rate of about 68.9% was shown. Also, as a result of measuring the weight change before and after drying of the combined electrode of Preparation Example 1, a weight decrease rate of about 14.14% was shown. It was confirmed therefrom that in Preparation Example 1, the solvent included in the active layer slurry and the adhesive was effectively removed in a drying process. In particular, since in Preparation Example 1, the weight decrease rate before and after drying of the active layer slurry was very large, it was confirmed again that Comparative Example 4 in which the active layer was not dried had decreased conductivity and degraded performance of the deionization electrode by not removing the solvent included in the active layer.

It was confirmed therefrom that a deionization electrode having the same or similarly good deionization performance as before without including an organic solvent in an adhesive for combining the active layer and the ion exchange membrane may be manufactured according to the manufacturing method of the present disclosure. In addition, it was confirmed that excellent deionization performance may be achieved by including a porous material with an aqueous binder in the adhesive. Also, it was confirmed that the conductivity of the deionization electrode may be improved from a composite drying process of removing the solvent included in the active layer by drying and drying the combined electrode to remove the solvent on the adhesive, thereby achieving excellent deionization performance.

TABLE 1

| | | Compar- | Compar- | Compar- | Compar- |
|---|---|---|---|---|---|
| Classifi- | Exam- | ative | ative | ative | ative |
| cation | ple 1 | Example 1 | Example 2 | Example 3 | Example 4 |
| Deion- | 77.32 | 77.68 | 31.10 | 53.11 | 50.21 |
| ization | | | | | |
| rate (%) | | | | | |

TABLE 2

| | Weight change depending on | | | Weight change depending on | | |
|---|---|---|---|---|---|---|
| | active layer drying | | | combined electrode | | |
| | Before | After | Reduction | Before | After | Reduction |
| Classification | drying (g) | drying (g) | rate (%) | drying (g) | drying (g) | rate (%) |
| Preparation | 53.05 | 16.5 | 68.9 | 19.8 | 17.00 | 14.14 |
| Example 1 | | | | | | |

Next, it was evaluated whether the CDI electrode cells manufactured in Example 1 and the comparative examples were able to maintain deionization performance in FIGS. 2 to 4 for a long time.

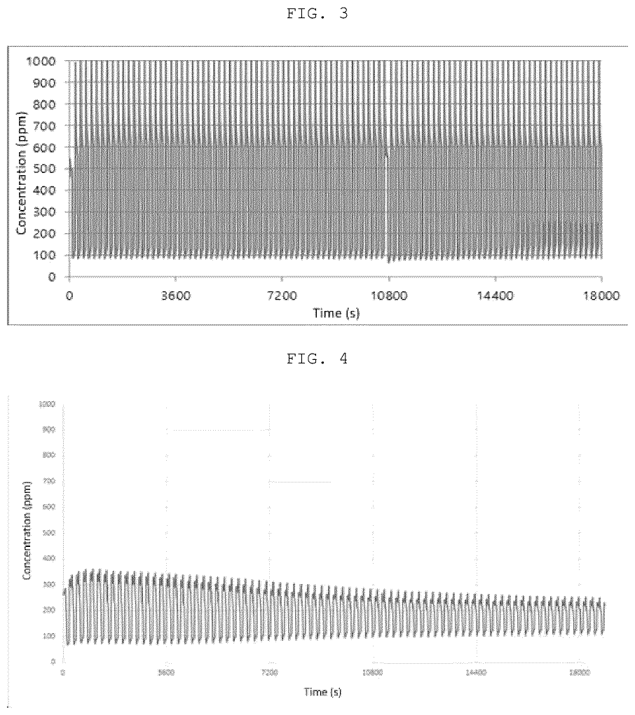

First, as a result of comparing the performance maintenance abilities of Comparative Example 1 using the adhesive including an NMP organic solvent and Example 1 in the conditions of 500 mg/L of NaCl solution, it was confirmed that in FIG. 2, Comparative Example 1 maintained the deionization rate of 77.68% evenly for a certain period of time, and in FIG. 3, in Example 1, an initial deionization rate of 77.32% was somewhat decreased to 70% over time, but after that, consistent performance was maintained without further decrease.

In addition, in FIG. 4, in Comparative Example 2, performance was gradually decreased over time from an initial deionization rate of about 75% to a deionization rate of about 50%, and thus, the performance was not maintained. It was confirmed therefrom that Comparative Example 2 did not maintain performance even in the conditions of influent water at a low concentration corresponding to a 250 mg/L NaCl solution and showed maintenance ability of significantly low deionization performance, but Example 1 was able to maintain deionization performance at a similar level of Comparative Example 1 using an adhesive including an organic solvent even in the conditions of high influent water corresponding to a 500 mg/L of NaCl solution.

From the results described above, it was confirmed that the manufacturing method of the present disclosure may produce a deionization electrode having excellent performance similar or equal to the conventional electrode, using an environmentally friendly adhesive including the aqueous solvent and the porous material, instead of the conventional adhesive including a toxic organic solvent.

In an exemplary embodiment of the present disclosure, an organic solvent-free capacitive deionization electrode may be manufactured.

In an exemplary embodiment of the present disclosure, a capacitive deionization electrode may be manufactured without using an organic solvent such as N-methyl-2-pyrrolidone and dimethylacetamide in an adhesive.

In an exemplary embodiment of the present disclosure, a capacitive deionization electrode which has excellent deionization performance and may maintain the performance, and a deionization electrode cell including the electrode may be manufactured.

Although the exemplary embodiments of the present disclosure have been described above, the present disclosure is not limited to the exemplary embodiments but may be carried out in various forms different from each other, and those skilled in the art will understand that the present disclosure may be implemented in other specific forms without changing the technical spirits or the essential feature of the present invention. Therefore, it should be understood that the exemplary embodiments described above are not restrictive, but illustrative in all aspects.

What is claimed is:

1. A method for manufacturing an organic solvent-free capacitive deionization electrode, the method comprising:
coating one surface or one and the other surfaces of a current collector with an active layer slurry including an electrode active material, an aqueous binder, a dispersant, and an aqueous solvent;
drying the active layer slurry;
combining the dried active layer and an ion exchange membrane using an adhesive including a porous material, an aqueous binder, and an aqueous solvent; and
drying an electrode in which the active layer and the ion exchange membrane are combined.

2. The method for manufacturing an organic solvent-free capacitive deionization electrode of claim 1, wherein the porous material is a conductive porous material and is any one or more selected from active carbon, graphene, aerosol, carbon nanotubes, metal organic framework, polypyrrole, and polyaniline.

3. The method for manufacturing an organic solvent-free capacitive deionization electrode of claim 1, wherein the aqueous binder is any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA).

4. The method for manufacturing an organic solvent-free capacitive deionization electrode of claim 1, wherein the adhesive includes 20 to 70 wt % of the porous material.

5. The method for manufacturing an organic solvent-free capacitive deionization electrode of claim 1, wherein the adhesive includes 30 to 80 parts by weight of the aqueous binder with respect to 100 parts by weight of the porous material.

6. The method for manufacturing an organic solvent-free capacitive deionization electrode of claim 1, wherein the adhesive includes 50 to 100 parts by weight of the aqueous solvent with respect to 100 parts by weight of the porous material.

7. The method for manufacturing an organic solvent-free capacitive deionization electrode of claim 1, wherein the active layer slurry is dried so that 95 wt % or more of the aqueous solvent based on the weight of the aqueous solvent included in the slurry is removed.

8. The method for manufacturing an organic solvent-free capacitive deionization electrode of claim 1, wherein the combined electrode is dried at a temperature of 20 to 80° C.

9. The method for manufacturing an organic solvent-free capacitive deionization electrode of claim 1, wherein the combined electrode is dried so that 80 wt % or more of the aqueous solvent based on the weight of the aqueous solvent included in the adhesive is removed.

10. The method for manufacturing an organic solvent-free capacitive deionization electrode of claim 1, wherein the combining uses a laminating combining method.

11. The method for manufacturing an organic solvent-free capacitive deionization electrode of claim 1, wherein the one and the other surfaces of the current collector are coated with the slurry using any one or more coating methods selected from comma, gravure, knife casting, doctor blade, and die coating.

12. An organic solvent-free capacitive deionization electrode comprising:
an active layer including an electrode active material, an aqueous binder, and a dispersant, which is formed on one surface or one and the other surfaces of a current collector;
an adhesive layer including a porous material and an aqueous binder, which is formed on the active layer; and
any one or more ion exchange membranes selected from a cation exchange membrane and an anion exchange membrane, which is formed on the adhesive layer.

13. The organic solvent-free capacitive deionization electrode of claim 12, wherein the porous material is a conductive porous material and is any one or more selected from active carbon, graphene, aerosol, carbon nanotubes, metal organic framework, polypyrrole, and polyaniline.

14. The organic solvent-free capacitive deionization electrode of claim 12, wherein the aqueous binder is any one or more selected from styrene butadiene rubber (SBR), polytetrafluoroethylene (PTFE), polyimide (PI), polyvinylpyrrolidone (PVP), polyvinyl alcohol (PVA), and polyacrylic acid (PAA).
